(19) United States
(12) Patent Application Publication
(10) Pub. No.: US 2010/0053153 A1
(43) Pub. Date: Mar. 4, 2010

(54) METHOD OF CODING DATA REPRESENTATIVE OF A MULTIDIMENSIONAL TEXTURE, CODING DEVICE, DECODING METHOD AND DEVICE AND CORRESPONDING SIGNAL AND PROGRAM

(75) Inventors: Jérôme Baril, Martignas (FR); Patrick Gioia, Servon-sur-Vilaine (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/524,744

(22) PCT Filed: Jan. 31, 2008
(86) PCT No.: PCT/FR08/50161

§ 371 Date: Oct. 2, 2009

(30) Foreign Application Priority Data
Feb. 1, 2007 (FR) 0752998

(51) Int. Cl. G06T 15/00

(52) U.S. Cl. 345/419

(57) ABSTRACT

The invention relates to a method of coding data representative of a multidimensional texture, said data being initially organized on a number of dimensions at least equal to three, at least one of said dimensions being associated with a rendition parameter for said texture, characterized in that it comprises the steps of:
wavelet analysis (C2) of said data on said dimensions,
and compression (C3) of data obtained from the result of said analysis.

The present invention falls within the field of graphics computing, and more specifically the field of the coding and compression of data for viewing virtual scenes.

The invention relates in fact to a method of coding multidimensional textures used for transmitting and generating photo-realistic synthesis images.

Representing the appearance of real surfaces is one of the main issues in graphics computing. The overall appearance of a surface is often defined with different scales.

The shape of the surface is placed at the roughest level, the macroscopic level, and corresponds to the geometry of the object for which the surface is to be represented. With the current rendition mode on graphics hardware, this geometry is more often than not expressed by a mesh, that is, a set of polygons.

The finest level, corresponding to the microstructure, determines the manner in which the surface interacts with its environment. It expresses the properties of a material: a surface made of wood will not reflect light in the same way as a metal surface. These interactions are represented in graphics computing by bilateral reflectance distribution functions (BRDF), four-dimensional functions dependent on the point of view and the direction of the light.

An intermediate layer, the mesostructure, encapsulates the geometrical details, such as small bosses on a granular surface for example. From an application point of view, this layer is often represented by a so-called disturbance of the normals, or “bump mapping” technique, or else by a method of geometrical variation of the points of the mesh along their normal, called “displacement mapping” method. This level disturbs the top layer because the local variations of the surface lead to a local variation of the light intensity, because of the creation of an occlusion or of a shadow for example.

By capturing the rendition of the surface, using a digital camera, from different points of view and several directions of the light, the complex calculation of the interactions between mesostructure and microstructure, necessary in order to perform the rendition of a surface, is circumvented. There are thus obtained functions called “bilateral texture functions” (BTF), described in the article by K. J. Dana, B. van Ginneken, S. K. Nayar and J. J. Koenderink, entitled “Reflectance and texture of real-world surfaces”, and published in the journal “Association for Computer Machinery (ACM) Transactions On Graphics” in 1999. These functions are expressed, for example, in the form:

BTF=BTF(x,y,θᵥ,φᵥ,θ₁,φ₁)

in which:
x and y represent the spatial coordinates expressed in parametric coordinates,
θᵥ and φᵥ define the direction of a point of view in polar coordinates,
and θ₁ and φ₁ define a direction of the light in polar coordinates.

A BTF thus corresponds to a set of images in which each image is associated with a point of view and a direction of the light. This capture method makes it possible to model in one go the mesostructure, the microstructure and all the interactions that exist between these two layers, for one and the same material. In order to ensure a soft transition between different points of view or directions of the light, a fine sampling is needed, which means that a BTF corresponds to a large number of images.

When transmitting the data corresponding to these modeled materials, also called textures or multidimensional textures, and when rendering these textures in real time, the raw information conveyed by the BTFs must therefore be expressed differently, in order to meet the data access speed and limited memory size constraints.

There are other methods similar to the latter that make it possible to obtain BTFs, which generate multidimensional textures by using fewer or more dimensions compared to the BTFs. Thus the “polynomial texture maps (PTM)” are textures in which only the direction of the light causes the appearance of the associated surface to vary. Similarly, the “time-varying BTFs” are BTFs to which a dimension is added, making it possible to cause the appearance of a surface to vary with time. These textures are also represented by a very large quantity of data which require an appropriate coding.

The existing coding techniques that can be used to compress the data of these multidimensional textures evolve essentially according to two approaches.

The first approach consists in approximating a multidimensional texture by continuous function models. For example, a texture expressed in the form of a BTF is approximated by models of BRDF functions, or by biquadratic polynomials.

In practice, since this BTF is expressed by a set of images, each being the photograph of the surface of a material corresponding to the texture from a given point of view and direction of the light, by classifying these data differently, the variation for each pixel according to the direction of the light concerned and according to the point of view concerned is obtained. In other words, this BTF is approximated by a set of models of BRDF functions:

BTF(z,v,l)≈{BRDF_{z}(v,l)};∀z

in which
z is the projection of the spatial coordinates x and y initially defining a pixel in the BTF, on a single dimension,
v is the projection of the initial polar coordinates θᵥ and φᵥ initially defining the direction of a point of view in the BTF, on a single dimension,
l is the projection of the initial polar coordinates θ₁ and φ₁ initially defining a direction of the light in the BTF, on a single dimension,
and BRDF_{z}(v,l) is a BRDF function model for the pixel z, in which the direction of the light and the direction of a point of view are each expressed on a single dimension.

Such methods of approximation by BRDF function models are notably described in the following articles:
“Reflectance field based real-time, high-quality rendering of bidirectional texture functions”, by J. Meseth, G. Müller and R. Klein, published in February 2004 in the journal “Computers and Graphics”,
“Efficient rendering of spatial bi-directional reflectance distribution functions”, by D. K. McAllister, A. Lastra and W. Heidrich, published on the occasion of a conference “ACM SIGGRAPH/EUROGRAPHICS conference on Graphics Hardware” in 2002,
and “Non-linear reflectance model for bidirectional texture function synthesis”, by J. Filip and M. Haindl, published in 2004 on the occasion of a conference “International Conference on Pattern Recognition (ICPR)”.

The BRDF function model used for this approximation is, for example, that of E. P. F. Lafortune, S-C. Foo, K. E. Torrance and D. P. Greenberg described in their article “Non-linear approximation of reflectance functions” published on the occasion of a conference “ACM SIGGRAPH” in 1997.

Similarly, a BTF is sometimes approximated by biquadratic polynomials:

BTF(z,v,θ₁,φ₁)≈{Pᵥ(z,θ₁,φ₁};∀v

in which
z is the projection of the spatial coordinates x and y defining a pixel initially in the BTF, on a single dimension,
v is the projection of the polar coordinates θᵥ and φᵥ initially defining the direction of a point of view in the BTF, on a single dimension,
and Pᵥ(z,θ₁,φ₁) is a biquadratic polynomial of approximation of the BTF for a given point of view.

The approximation-based methods according to this first approach make it possible to obtain a compact and continuous representation of the textures, which adapts well to the current rendition algorithms, normally performed directly on programmable graphics cards. They are, however, limited by the complexity of the necessary calculations. In practice, while a breakdown in singular values of a BTF is sufficient to obtain an approximation by biquadratic polynomials, the approximation of the same function by BRDF function models often proves very complex to resolve. Furthermore, these approximations do not make it possible to render the variety of the effects captured on acquisition of the BTFs. The effects associated with the displacements of the point of view or of the direction of the light would require, in order to be taken into account, the use of even more complex BRDF function models, or different polynomials, as described in the articles:
“A reflectance model for computer graphics”, by R. L. Cook and K. E. Torrance, published in 1982 in the magazine “ACM Transactions On Graphics”,
or “Measuring and modeling anisotropic reflection” by G. J. Ward, published on the occasion of a conference “ACM SIGGRAPH” in 1992.

In addition, the specularities and singularities, such as occlusions or shadings, induced by the mesostructure of the modeled surfaces, are supplanted by these approximation-based methods.

The second approach consists in performing a linear-based breakdown of a multidimensional texture. Given a texture, expressed for example in the form of a BTF, this BTF being similar to a multidimensional signal, a main components analysis, or breakdown into singular values, is applied. This method consists in searching for the directions in space that best represent the correlations of the set of data that is the BTF. A new base is then defined, resulting from the orthogonalization of the analysis field by a search for the specific vectors and specific values of the covariance matrix associated with the BTF. The axes of the new associated frame of reference are such that the variance of the initial samples of the BTF is maximum. The specific vectors are then sorted by order of importance, according to their corresponding specific values, in descending order. Only the most influential axes are thus retained. The initial data of the BTF are then projected into this new space of reduced dimensions. There is therefore obtained, by linear combination, an approximation of the original signal in this new base:

$$B T F ( x , y , {θ}_{v} , {φ}_{v} , {θ}_{l} , {φ}_{l} ) \approx {\sum }_{i = 1}^{c} {g}_{i} ( x , y ) \cdot {h}_{i} ( {θ}_{v} , {φ}_{v} , {θ}_{l} , {φ}_{l} )$$

in which the functions gᵢ represent the weights deriving from the projection in the new base {hᵢ}, consisting of c vectors deriving from the reduction of dimensionality.

The existing methods based on this second approach differ by the choice of the data to be analyzed and on how the breakdown is organized.

Thus, some methods use all the data of the BTF as analysis space, as for the above equation and as described in the article by M. L. Koudelka, S. Magda, P. N. Belhumeu and D. J. Kriegman, entitled “Acquisition, compression and synthesis of bidirectional texture functions” and published on the occasion of an international workshop “Texture Analysis and Synthesis” in 2003.

Other methods use a representation by point of view in order to exploit the coherence on a change of direction of the light, stronger than on a change of point of view:

$$B T F ( z , v , l ) \approx \{ B T {F}_{v} ( z , l ) \} , ∀ v$$

$$with$$

$$B T {F}_{v} ( z , l ) \approx {\sum }_{i = 1}^{c} {g}_{v , i} ( l ) \cdot {h}_{v , i} ( z )$$

in which the functions g_{v,i} represent the weights deriving from the projection in a new base {h_{v,i}} of a sample BTFᵥ(z,l) corresponding to the data of the BTF BTF(z,v,l) for a given point of view v. These methods of representation by point of view are described in the articles:
“Efficient and realistic visualization of cloth”, by M. Sattler, R. Sarlette and R. Klein, published on the occasion of an international conference “Eurographics Symposium on Rendering” in 2003,
and “Preserving realism in real-time rendering of bidirectional texture functions”, by J. Meseth, G. Müller and R. Klein, published on the occasion of an international conference “OpenSG Symposium” in 2003.

The same authors, G. Müller, J. Meseth and R. Klein, in their articles “Compression and real-time rendering of measured BTFs using local Principal Component Analysis (PCA)”, presented at the international workshop “Vision, Modeling and Visualisation” in 2003, and “Fast environmental lighting for local-PCA encoded BTFs”, published on the occasion of the international conference “Computer Graphics International (CGI)” in 2004, propose a block representation of the multidimensional textures by grouping together into packets the data that have the greatest likelihood. The analysis is then performed on each block individually and the analytical approximation of the associated BTF is:

$$B T F ( z , v , l ) \approx {\sum }_{i = 1}^{{c}_{b}} {g}_{k ( z ) , i} ( z ) \cdot {h}_{k ( z ) , i} ( v , l )$$

in which the functions g_{k(z)},ᵢ represent the weights deriving from the projection in new bases {h_{k(z),i}}, of the BTF BTF(z,v,l) in which the data have been grouped together in blocks according to the most correlated pixels, k(z) being a function corresponding to a mapping table associating a pixel with a likelihood block.

Still according to this second approach, a multiresolution method is proposed by W.-C. Ma, S.-H. Chao, Y.-T. Tseng, Y.-Y. Chuang, C.-F. Chang, B.-Y. Chen and M. Ouhyoung, in their article “Level-of-detail representation of bidirectional texture functions for real-time rendering”, published in 2005 on the occasion of an international conference “Symposium on Interactive 3D graphics and games”. They first of all produce a transformation of the initial domain as Laplace pyramid for each pixel. This pyramid, made up of several levels, is constructed by filtering the highest level of detail to obtain a lower resolution representation. The coefficients of the pyramid are then broken down by a main components analysis.

Finally, M. A. O. Vasilescu and D. Terzopoulos, in their article “Tensortextures: multilinear image-based rendering”, published in 2004 in the journal “ACM Transactions On Graphics”, propose a multilinear method: they break down the BTF into tensor products. Each tensor represents two dimensions of the BTF:
a spatial tensor represents the projection of the spatial coordinates x and y on a single dimension,
a tensor associated with the point of view represents the projection of the polar coordinates θᵥ and φᵥ on a single dimension,
and a tensor associated with the direction of the light represents the projection of the polar coordinates θ₁ and φ₁ on a single dimension.

These tensors are calculated using a breakdown into singular values in three dimensions, each dimension representing a doublet as stated previously. This method therefore allows for a finer reduction of dimension in that it makes it possible to favor a dimension, that is to say a tensor, individually. The decimation is therefore not totally random over all of the BTF because the approximation error can be targeted according to the number of main components retained for each dimension.

The breakdown-based methods according to this second approach improve the qualitative results compared to the approximation-based methods, the choice of the number of main components determining the quality of the textures compressed by such methods. They also define a compact and discrete representation of the multidimensional textures. This compactness is due to the fact that the vectors deriving from the breakdown are classified by order of importance and only the most representative vectors are taken into account. However, this decimation is random and does not make it possible to define which details to block out on the transformation. It also supplants certain singularities captured in the acquisition process, the substituted axes corresponding to areas of low correlation. This lack of frequency-domain information limits the flexibility of these methods: they do not make it possible to supply directly a representation according to different levels of detail, by a progressive decoding of the information. A multiresolution representation of the textures compressed by these methods entails, as in the article “Level-of-detail representation of bidirectional texture functions for real-time rendering”, additional transformations.

It should also be noted that the breakdown-based multiresolution method mentioned in this article in fact produces a representation of texture by resolution and does not therefore correspond to a single multiresolution representation allowing for a progressive decoding of the information according to a choice of resolution.

Furthermore, since these methods supply a discrete representation, they require, when a high level of detail is needed over an area of a texture when it is being rendered, an interpolation over all of the dimensions of this texture using neighboring samples deriving from the acquisition process.

The existing methods of texture compression do not therefore make it possible to retain all the captured details of a texture, nor do they make it possible to supply a progressive decoding of the texture information in order to adapt to the hardware constraints when transmitting this information, associated for example with the power of the graphics cards of the receivers or the bit rate of the network used. This capability is, however, necessary in order to extend the use of the textures to decentralized systems or to a wider range of peripheral devices, such as mobile terminals.

The aim of the present invention is to resolve the drawbacks of the prior art by in particular providing a method and a device for coding data representative of a multidimensional texture, using the properties of the wavelet analysis on all of the dimensions of this texture.

To this end, the invention proposes a method of coding data representative of a multidimensional texture, said data being initially organized on a number of dimensions at least equal to three, at least one of said dimensions being associated with a rendition parameter for said texture, characterized in that it comprises the steps of:
wavelet analysis of said data on said dimensions,
and compression of data obtained from the result of said analysis.

Thanks to the invention, a multidimensional texture representation is obtained that is effectively compressed: the compression rate obtained is better than in the prior art, while retaining a good level of detail and requiring only a low calculation complexity, which makes it possible to reconstruct the initial data in real time when rendering. In practice, although multilinear algebra sometimes proves costly when synthesizing, that is, when decoding, the tensors used in the invention are hollow, that is to say that most of their coefficients are zero, which, in practice, means few calculations.

The high compression rate obtained by the coding method according to the invention makes it possible to retain a very good quality texture representation, which in particular retains all the effects associated with the displacement of the point of view or of the direction of the light.

These benefits are associated with the properties of the wavelet analysis, which exploits the dimensional and interdimensional correlation without prior transformation. In addition, the wavelet analysis corresponds to a frequency analysis of an initial signal, which is broken down into frequency bands. Because of this, it is possible to target the decimation frequency-wise and to do so for each dimension of the signal. This makes it possible to retain all the singularities of the texture compressed according to the invention.

This analysis is also a multiresolution analysis, it produces a representation of the initial signal by scale, in which the low-frequency coefficients are qualified as the roughest level and the reconstruction from the high-frequency coefficients is qualified as the finest level. This characteristic makes it possible to define different levels of details from one and the same texture representation. It also makes it possible to represent the texture information progressively: in such a representation, the data are organized by order of importance, the coefficients minimizing the reconstruction error being placed at the beginning. The principle of this representation consists in adding details to the approximation of the original signal.

Thus, if the transmission over a network or to a processor of texture data coded according to the invention is interrupted, for example to comply with certain criteria such as the size of the data received, the information already transmitted will be usable. Another benefit of this progressive representation is the possible adaptation of the texture data coded according to the invention to different types of graphics devices, not having the same capabilities in terms of computation and memory size, such as virtual reality centers, office computers or mobile peripheral devices. This progressive representation also makes it possible to adapt the data to the transmission bit rate in a decentralized application.

Another benefit associated with the wavelet analysis is that the coding according to the invention is made extremely configurable: depending on whether a best possible quality representation or a most compact possible representation is favored, a loss-less compression or a lossy compression is chosen.

It is also possible to perform the coding according to the invention on parallel architecture devices or systems, such as the current graphics processors called graphics processing units (GPU), multicore processors or a cluster of personal computers.

It should be noted that, because of its benefits associated with the possibilities of progressive representation of the texture data, and of parallel calculations, the coding method according to the invention is compatible with the “peer-to-peer” virtual browsing systems which require a resistance to failures and great information transmission flexibility. It makes it possible in particular to transmit texture data in parallel from different senders, to receivers of very different capabilities.

Finally, the coding method according to the invention allows dynamic and fast access to the texture data coded according to the invention. In practice, there is no need to reconstruct all the initial data on each new image of one and the same texture when it is rendered, because the coding of the data according to the invention allows for a local reconstruction of areas of interest.

According to a preferred characteristic, the coding method according to the invention comprises a preliminary step for reorganization of said data representative of a multidimensional texture according to a predetermined number of dimensions.

This step of reorganization of the texture data makes it possible to simplify the breakdown into wavelets, by reducing the number of dimensions in particular.

According to another preferred characteristic, in said reorganization step, said data is arranged so as to maximize the correlation between two successive samples of said data according to at least one dimension.

By maximizing the correlation between samples before the breakdown into wavelets, the compression of the data on coding thereof is improved.

According to another preferred characteristic, said data representative of a multidimensional texture represent colors according to the YUV color coding system.

The use of the YUV color coding system instead of a conventional red/green/blue RGB coding system, to represent the colors of the texture coded according to the invention, makes it possible to obtain, for an equivalent visual quality, better compression rates. In practice, since the human eye is less sensitive to the chromatic variations and more sensitive to luminance, this choice makes it possible, in the quantization step associated with the coding, to code less accurately the U and V parameters representative of the chromaticity than the Y parameter representative of the luminance.

According to another preferred characteristic, the compression step of the coding method according to the invention uses a “zerotree” type coding.

This type of coding makes it possible to optimize the compression of the texture data that have been wavelet-analyzed.

The invention also relates to a method of decoding data representative of a multidimensional texture, said data being initially organized on a number of dimensions at least equal to three, at least one of said dimensions being associated with a rendition parameter for said texture, characterized in that it comprises the steps of:
decompression of said data,
and wavelet synthesis on said dimensions of data obtained from said decompression.

The invention also relates to a signal representative of a multidimensional texture initially represented by data organized on a number of dimensions at least equal to three, at least one of said dimensions being associated with a rendition parameter for said texture, characterized in that said data have been coded by wavelet analysis on said dimensions, then by compression of data obtained from the result of said analysis.

The invention also relates to a device for coding data representative of a multidimensional texture, said data being initially organized on a number of dimensions at least equal to three, at least one of said dimensions being associated with a rendition parameter for said texture, characterized in that it comprises:
wavelet analysis means for said data on said dimensions,
and compression means for data obtained from said analysis means.

The invention also relates to a device for decoding data representative of a multidimensional texture, said data being initially organized on a number of dimensions at least equal to three, at least one of said dimensions being associated with a rendition parameter for said texture, characterized in that it comprises:
decompression means for said data,
and wavelet synthesis means on said dimensions of data obtained from said decompression means.

The decoding method, the signal, the coding device and the decoding device offer benefits similar to those of the coding method according to the invention.

The invention finally relates to a computer program comprising instructions for implementing the coding method according to the invention or the decoding method according to the invention, when it is run on a computer.

Other characteristics and benefits will become apparent from reading about a preferred embodiment described with reference to the figures in which:

FIG. 1 represents the sampling of the acquisition of a BTF modeling a texture,

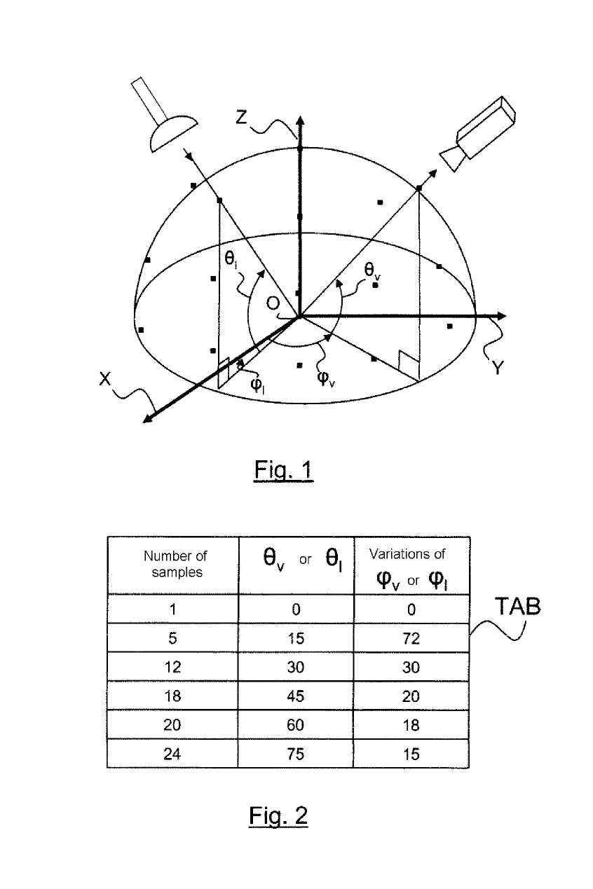

FIG. 2 is a table illustrating the values of this sampling,

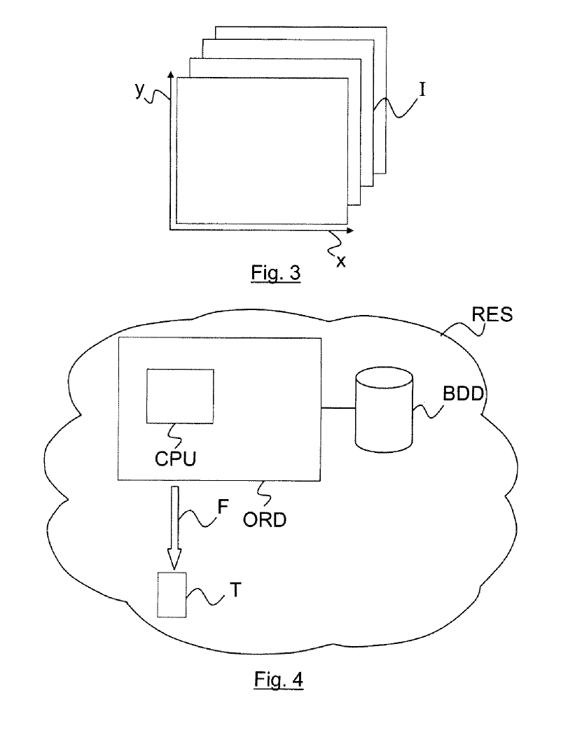

FIG. 3 represents an interpretation of this BTF,

FIG. 4 represents an embodiment of the coding method and of the decoding method according to the invention,

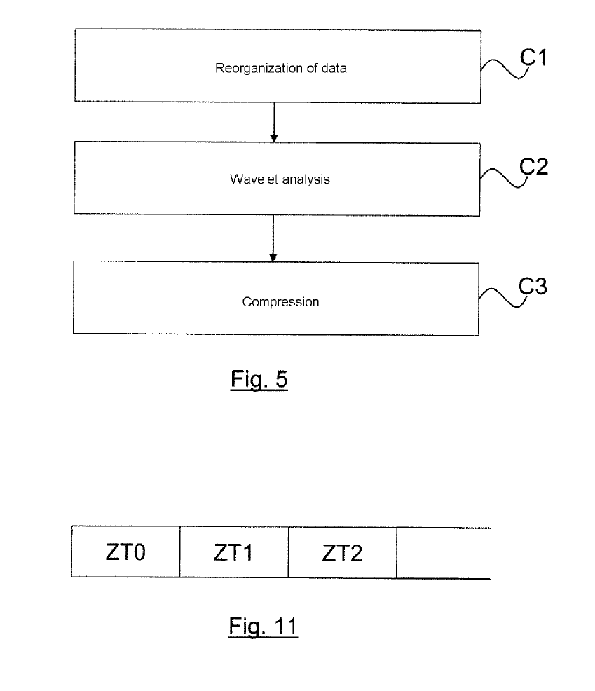

FIG. 5 represents the steps of the coding method according to the invention, as described in this embodiment,

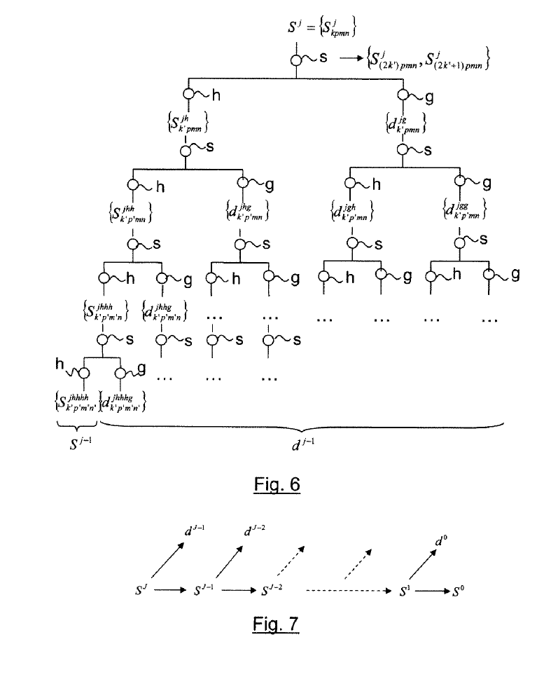

FIG. 6 represents a level of breakdown into wavelets of texture data,

FIG. 7 represents a breakdown into wavelets of texture data,

FIG. 8 represents a tree showing the breakdown of texture data into wavelet packets,

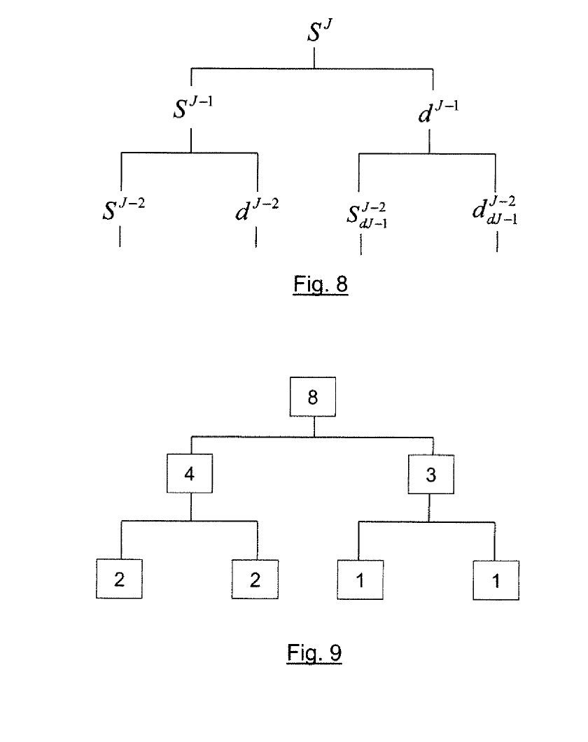

FIG. 9 represents the allocation of costs to the elements of this breakdown into wavelet packets,

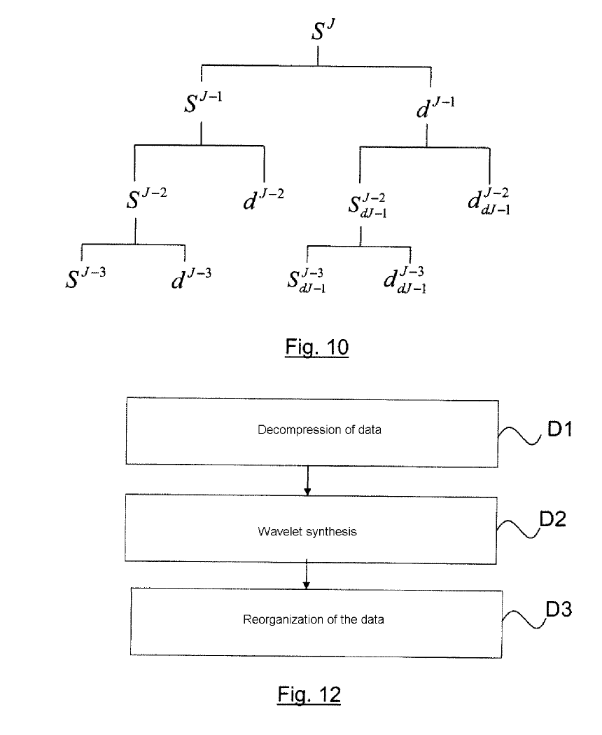

FIG. 10 represents another tree showing the breakdown of texture data into wavelet packets,

FIG. 11 represents a format for representation of texture data coded according to the invention,

FIG. 12 represents the steps of the decoding method according to the invention as described in this embodiment.

According to a preferred embodiment of the invention, the coding method according to the invention is used to compress a multidimensional texture expressed in the form of a six-dimensional BTF. However, since the breakdown into wavelets can be extended to any number of dimensions, the method according to the invention is also applicable to multidimensional textures that are represented differently, for example in the form of “polynomial texture map” in four dimensions or “time-varying BTF” in seven dimensions.

The BTF expressing this texture is the result of an acquisition process represented in FIG. 1. The BTF is sampled according to a hemisphere of shots. In the orthonormal frame of reference of origin O and of axes X, Y and Z, each point of the texture is thus photographed from a point of view direction of polar coordinates θᵥ and φᵥ, and from a direction of the light of polar coordinates θ₁ and φ₁.

The table TAB of FIG. 2 indicates the number of photographs taken for a given latitude θᵥ and φ₁. Thus, for a latitude θᵥ equal to 15 degrees, the angle φᵥ varies by 72 degrees to 72 degrees, which corresponds to five photographs taken for this latitude. By adding together the values of the number of samples on the first column, there are therefore 80 point-of-view-direction values and 80 direction-of-light values used for the sampling, which produces a BTF made up of 6400 images.

FIG. 3 illustrates this interpretation of the BTF: each of the images I of these 6400 images represents the texture in parametric coordinates x and y, and corresponds to a direction of point of view (θᵥ,φᵥ) and a direction of the light (θ₁,φ₁).

It should be noted that data similar to BTF can be downloaded from the Bonn university site at the internet address http://btf.cs.uni-bonn.de/, the acquisition mode for these data being more fully detailed in the article by G. Müller, G. H. Bendels and R. Klein entitled “Rapid synchronous acquisition of geometry and BTF for cultural heritage artefacts”, published in November 2005 on the occasion of a conference “6th International Symposium on Virtual Reality, Archaeology and Cultural Heritage (VAST)”.

In addition, since the sampling is not regular and has boundary areas, the coding method according to the invention uses wavelets that are obviously “second-generation” type wavelets, because the first-generation wavelets are not suited to this type of sampling.

The images I forming the data of the BTF are stored in a database BDD represented in FIG. 4, the coding method according to the invention being implemented in this embodiment in a software manner in a computer ORD having access to this database. The calculations necessary to the coding method according to the invention are performed in the processor CPU of the computer ORD. As a variant, given the scale of the size of the data on which the calculations necessary for their coding are performed, these calculations are performed on several computers running in parallel.

Referring to FIG. 5, the coding method according to the invention is represented in the form of an algorithm comprising steps C1 to C3.

The first step C1 is a reorganization of the data of the BTF, the data of which are initially organized in six dimensions, into a reduced number of dimensions, so as to limit the complexity of the calculations. The choice of this number of dimensions depends on applications using the compressed data, depending on whether preference is given to less complex calculations or a greater compression rate. In practice, the more dimensions that are kept, the more the interdimensional coherence is exploited and the greater the compression ratio becomes. In this embodiment, a reorganization of the data of the BTF in four dimensions is chosen, representing a tradeoff between speed and compression:

BTF(x,y,θᵥ,φᵥ,θ₁,φ₁)=BTF(x,y,v,l)

in which
v is the projection of the initial polar coordinates θᵥ and φᵥ initially defining the direction of a point of view in the BTF, on a single dimension,
and l is the projection of the initial polar coordinates θ₁ and φ₁ initially defining a direction of the light in the BTF, on a single dimension.

As a variant, the data of the BTF are not reorganized, the wavelet analysis then being done on six dimensions. In this variant, two types of wavelets are used for example:
wavelets in two inseparable dimensions, in order to adapt the analysis filters to the sampling of the BTF according to the directions of the point of view and the light,
and wavelets in a separable dimension for the spatial analysis.

In another variant embodiment, the initial data of the BTF are reorganized in three dimensions according to a “reflectance field” breakdown, in other words, it is expressed by point of view v and the direction of the light is projected on a single dimension:

BTF(x,y,θᵥ,φᵥ,θ₁,φ₁)={BTF(x,y,l)},∀ᵥ

In another variant embodiment, the data of the BTF are reorganized in five dimensions, the direction of the light being projected on a single dimension:

BTF(x,y,θᵥ,φᵥ,θ₁,φ₁)=BTF(x,y,θᵥ,φᵥ,l)

The latter variant is interesting for example when the direction of the point of view is sampled more than the direction of the light.

In this step C1 for reorganizing the data of the BTF, the projection v corresponding to the doublet (θᵥ, φᵥ) is classified in ascending order according to θᵥ and φᵥ, that is, depending on the dimension of the point of view v the images I are classified in the following sampling order: (0,0), (15,0), (15,72), . . . , (75,345). Similarly, the projection 1 corresponding to the doublet (θ₁,φ₁) is classified in ascending order according to θ₁ and φ₁.

As a variant, the images I are classified so as to maximize the correlation between two successive images depending on the direction of the light. This classification is done, for example, in the following manner on all the images having one and the same point of view direction in common:
a root image in this set is chosen, for example the image of projection l corresponding to the doublet (0,0) in polar coordinates,
the next image is then sought iteratively from the preceding image, this image corresponding to the image that minimizes the difference between the preceding image and the set of images not already classified.

This classification of the images I in order of likelihood according to the axis corresponding to the projection l, makes it possible thereafter to improve the compression in the step C3.

It should also be noted that the data of the BTF are coded on acquisition in the RGB format. Now this color coding format does not make it possible to exploit the perception factor to its maximum. In practice, since the human eye is particularly sensitive to changing luminance, this step C1 preferably includes a change from RGB color space to YUV color space, in which Y represents the luminance, and U and V the chrominance. This change has an impact on the remainder of the processing operation because the point of such a modification is to provide a greater quantity of information for the luminance compared to the chrominance for the quantization in the step C3.

The second step C2 of the coding method is the wavelet analysis of the duly reorganized and reformatted data, on the four dimensions chosen in the step C1.

It should be noted that the expression “wavelet analysis” means that a signal is broken down into wavelets or into packets of wavelets, by successive wavelet transforms. A wavelet analysis therefore covers at least one wavelet breakdown.

This wavelet breakdown is done according to the organization chosen in the step C1. As indicated hereinabove, the use of second-generation wavelets is necessary because of the irregularity of the sampling intervals and the boundary areas. It should also be noted that even assuming that new samples are synthesized in the step C1 in order to regularize these intervals, the analysis domain still remains bounded so second-generation wavelets are still necessary.

In the interests of simplicity in this embodiment, a simple first-order “Unbalanced Haar Transform” type wavelet transform is used, which makes use of orthogonal second-generation wavelets which are easy to construct using the “lifting scheme” method. This construction is detailed in a course by W. Sweldens and P. Schröder, entitled “Building your own wavelets at home” and published in 1996 by ACM SIGGRAPH in “Wavelets in Computer Graphics”. Since these wavelets are separable, the breakdown is performed on each dimension in turn which makes it possible to remain independent of the organization of the data chosen in the step C1. Furthermore, by using the Haar wavelet base, no adaptation at the boundaries is necessary because the breakdown is performed on two successive samples, in other words, the calculation of the breakdown close to the boundaries does not require the addition of dummy samples. Finally, in order to simplify this breakdown and because of the reorganization of the data in four dimensions in the step C1, it can be considered in this step C2 that the sampling intervals are regular.

As a variant, if the data of the BTF are reorganized in the step C1 according to a number of dimensions greater than four, the calculations are weighted at the time of the breakdown into wavelets in order to transform an irregular interval into a regular interval and obtain a situation which boils down to the regular case. This weighting makes it possible to make the breakdown into wavelets more faithful to reality, that is, at the time of decompression, the decompressed data can be used to synthesize new and very realistic texture views.

As a variant, higher order, more complex based wavelets are used in this breakdown. This makes it possible, at the cost, however, of more complex and longer calculations, to retain, despite the compression, a texture representation of very good resolution. Biorthogonal wavelets are used for example, which are practical for their ease of construction using the “lifting scheme” method, or geometrical wavelets are used by considering the spatial configuration of the texture as a geometry in a same-dimension space. For example, on data reorganized in the step C1 on three dimensions, mesh-based wavelets are used that use as primitive the quadrilateral, and by applying conventional subdivision techniques such as the “butterfly” technique. Generally, the use of a wavelet base having two zero moments is a good tradeoff for reconciling playback quality with calculation speed.

More specifically, in the main variant embodiment of the coding method according to the invention, the breakdown into wavelets in the step C2 is done at each breakdown level j according to the scheme of FIG. 6. Let S^{j} be the signal formed from the set of the data {Sₖₚₘₙ^{j}} of the jth level of breakdown into wavelets in the Haar base, from the reorganized data obtained at the end of the step C1, and in which:
k is an index representing the kth value of the signal according to the axis of the spatial coordinate x,
p is an index representing the pth value of the signal according to the axis of the spatial coordinate y,
m is an index representing the mth value of the signal according to the axis of the projection l,
and n is an index representing the nth value of the signal according to the axis of the projection v.

The breakdown is done on each dimension in turn, by data block each corresponding to all the values of the BTF according to one dimension, when each of the other three dimensions is set to a given value. The order of processing of these dimensions is chosen according to the correlation of the data of the BTF. Since the spatial correlation of the texture is stronger than its correlation on a change of direction of the light, it is even stronger than on a change of direction of point of view, and the breakdown into wavelets is performed first according to the index k, then according to the index p, then according to the index m and finally according to the index n.

Thus, on its breakdown into wavelets, the signal S^{j} is first subjected, according to the axis of the spatial coordinate x, to the following functions:
the “split” operator s separates the data of even index and the data of odd index in the direction concerned, therefore here according to the index k:

{Sₖₚₘₙ^{j}}={S_{(2k′)pmn}^{j}, S_{(2k′+1)pmn}^{j}}

where k′ is an integer index defined by:
k=2k′ when k is even
and k=2k′+1 when k is odd,
the low-pass filter h performs the averages of the data {Sₖₚₘₙ^{j}} according to the direction concerned, which produces the data {S_{k′pmn}^{jh}} defined by:

$${S}_{{k}^{′} pmn}^{jh} = \frac{{S}_{( 2 {k}^{′} ) pmn}^{j} + {S}_{( 2 {k}^{′} + 1 ) pmn}^{j}}{2}$$

and the high-pass filter g calculates the differences between the data {Sₖₚₘₙ^{j}} according to the direction concerned, which produces the data {d_{k′pmn}^{jg}} defined by:

d_{k′pmn}^{jg}=S_{(2k′+1)pmn}^{j}−S_{(2k′)pmn}^{j}

In reality, the breakdown is performed according to the “lifting scheme” method, which means that for the breakdown in the Haar base the difference between two values of the signal S^{j} is calculated first, then the sum of these two values is calculated from this difference:

$${d}_{{k}^{′} pmn}^{jg} = {S}_{( 2 {k}^{′} + 1 ) pmn}^{j} - {S}_{( 2 {k}^{′} ) pmn}^{j}$$

$$then$$

$${S}_{{k}^{′} pmn}^{jh} = {S}_{( 2 {k}^{′} ) pmn}^{j} + \frac{{d}_{{k}^{′} pmn}^{jg}}{2}$$

This enables the processor CPU to store the value of d_{k′pmn}^{jg} in the same place as the value of S_{(2k′+1)pmn}^{j}, then to store the value of S_{k′pmn}^{jh} in the same place as the value of S_{(2k′)pmn}^{j}. This makes it possible to save memory space at the processor CPU level. Furthermore, the local nature of the breakdown into wavelets, in this case on two successive samples, enables the breakdown to be performed in an “out of core” manner, that is, all the data to be processed is not entirely contained in the main memory. This characteristic also enables the data to be processed in parallel by several processors. Furthermore, unlike the methods of the prior art, the analysis domain does not need to be segmented to be processed in its entirety.

The data {S_{k′pmn}^{jh}} and {d_{k′pmn}^{jg}} are then subjected to the same functions but according to the index p:
the operator s separates the data {S_{k′pmn}^{jh}} and the data {d_{k′pmn}^{jg}} according to their even or odd indices,
the filter h produces, from the data {S_{k′pmn}^{jh}}, the data {S_{k′p′mn}^{jhh}} and, from the data {d_{k′pmn}^{jg}}, the data {d_{k′p′mn}^{jgh}},
and the filter g produces, from the data {S_{k′pmn}^{jh}}, the data {d_{k′p′mn}^{jhg}} and, from the data {d_{k′pmn}^{jg}}, the data {d_{k′p′mn}^{jgg}},
   in which p′ is an integer index defined by:
p=2p′ when p is even,
and p=2p′+1 when p is odd.

Then, all of the data {S_{k′p′mn}^{jhh}}, {d_{k′p′mn}^{jhg}}, {d_{k′p′mn}^{jgh}} and {d_{k′p′mn}^{jgg}} obtained are once again subjected to the same functions, but according to the index m. Thus, if only the breakdown of the data {S_{k′p′mn}^{jhh}} is described:
the operator s separates these data according to their even or odd indices:
   {S_{k′p′}ₘₙ^{jhh}}={S_{k′p′(2m′)n}^{jhh}, S_{k′p′(2m′+1)n}^{jhh}}
   in which m′ is an integer index defined by:
m=2m′ when m is even,
and m=2m′+1 when m is odd,
the filter h produces, from the data {S_{k′p′mn}^{jhh}} the data {S_{k′p′m′n}^{jhhh}} defined by:

$${S}_{{k}^{′} {p}^{′} {m}^{′} n}^{jhhh} = \frac{{S}_{{k}^{′} {p}^{′} ( 2 {m}^{′} ) n}^{jhh} + {S}_{{k}^{′} {p}^{′} ( 2 {m}^{′} + 1 ) n}^{jhh}}{2}$$

and the filter g produces, from the data {S_{k′p′mn}^{jhh}} the data {d_{k′p′m′n}^{jhhg}} defined by:

d_{k′p′m′n}^{jhhg}=S_{k′p′(2m′+1)n}^{jhh}−S_{k′p′(2m′)n}^{jhh}

Finally, all of the data obtained in this way by breakdown according to the index m are broken down according to the index n. If only the breakdown of the data {S_{k′p′m′n}^{jhhh}} is described:
the operator s separates the data of even index and the data of odd index:

{S_{k′p′m′n}^{jhhh}}={S_{k′p′m′(2n′)}^{jhhh}, S_{k′p′m′(2n′+1)}^{jhhh}}

where n′ is an integer index defined by:
n=2n′ when n is even
and n=2n′+1 when n is odd,
the filter h performs the averages of the data {S_{k′p′m′n}^{jhhh}} according to the index n, which produces the data {S_{k′p′m′n′}^{jhhhh}} defined by:

$${S}_{{k}^{′} {p}^{′} {m}^{′} {n}^{′}}^{jhhhh} = \frac{{S}_{{k}^{′} {p}^{′} {m}^{′} ( 2 {n}^{′} )}^{jhhh} + {S}_{{k}^{′} {p}^{′} {m}^{′} ( 2 {n}^{′} + 1 )}^{jhhh}}{2}$$

and the filter g calculates the differences between the data {S_{k′p′m′n}^{jhhh}} according to the index n, which produces the data {d_{k′p′m′n′}^{jhhhg}} defined by:

d_{k′p′m′n′}^{jhhhg}=S_{k′p′m′(2n′+1)}^{jhhh}−S_{k′p′m′(2n′)}^{jhhh}

All of the data produced on this last breakdown according to the index n forms the result of the breakdown into wavelets of the signal S^{j}, or the data of the j−1th level of breakdown into wavelets of the data obtained at the end of the step C1. In this result, the data {S_{k′p′m′n′}^{jhhhh}}, which form a low-frequency, low-resolution signal S^{j-1}, and the other data that form a higher frequency signal d^{j-1}, are distinguished.

In a variant embodiment, the breakdown detailed hereinabove is a conventional breakdown into wavelets of the initial signal S^{J} formed from the data obtained in the step C1. In this breakdown represented in FIG. 7, only the low-frequency signal S^{J-1} is further broken down to the next level of breakdown, the detail signal d^{J-1} being retained. Thus, at the J−1th level of breakdown, the signal S^{J-1} is broken down into wavelets and produces a signal S^{J-2} of lower frequency than the signal S^{J-1}, and a signal d^{J-2} of lower frequency than the signal d^{J-1}, then at the next level of breakdown the signal S^{J-2} is itself broken down into wavelets and so on. The final breakdown into wavelets on the signal S¹ produces the signals d⁰ and S⁰. Since the data obtained at the end of the step C1 are the images I coded according to the YUV format and classified according to 80 directions of point of view and 80 directions of light, assuming that these images are of resolution 256*256, the process is stopped, for example, after three levels of breakdown into wavelets. The result of the wavelet analysis is then formed by the signals S⁰, and d⁰ to d^{J-1}, where J is three. The low-frequency signal S⁰ contains 10*10*32*32 colors coded in the YUV color space.

In the main variant embodiment of the coding method according to the invention, in order to code the texture optimally, the data obtained at the end of the step C1 is in fact broken down in this step C2 into packets of wavelets. Such a breakdown makes it possible to break down not only recursively the low-frequency signals S^{j}, but also the high-frequency signals d^{j}. This breakdown is represented in the tree of FIG. 8. The root of the tree corresponds to the initial signal S^{J} containing the data obtained at the end of the step C1. The next level is the result of an iteration of transformation into wavelets, that is, the low-frequency signal S^{J-1} and the high-frequency signal d^{J-1}. Then the recursive breakdown of these signals completes the lower levels of the tree. Thus, the breakdown of the signal S^{J-1} gives two signals S^{J-2} and d^{J-2}, whereas the breakdown of the signal d^{J-1} also gives two signals S_{dJ-1}^{J-2} and d_{dJ-1}^{J-2}.

This breakdown into packets of wavelets makes it possible to choose a breakdown tree that is optimal according to a given criterion, such as the entropy of the coding, a predetermined threshold, or the distortion generated by the coding. For this, a cost function is allocated to each breakdown into wavelets, that is, to each node of the tree represented in FIG. 8. This cost function corresponds to the criterion chosen to optimize the tree.

For example, if a choice is made to favor the breakdowns over the number of values below a threshold, the value of the cost function at the breakdown node corresponding to the signal S^{j} will have the value:

$$cost = {\sum }_{k} {\sum }_{l} {\sum }_{m} {\sum }_{n} P ( {S}_{klmn}^{j} )$$

with P(Sₖⱼₘₙ^{j})=1 if |Sₖₗₘₙ^{j}|>t and P(Sₖₗₘₙ^{j})=0 otherwise, where t corresponds to this threshold.

Then, the sum of the costs of the children of each parent of the tree is compared with the cost of this parent. If this sum is lower than the cost of the parent, the breakdowns of the children are retained, otherwise the process is stopped at the parental breakdown thereafter in the coding method.

For example, in the tree of FIG. 9, where each node of FIG. 8 has been replaced by the cost of its breakdown, the breakdown into packets of wavelets will be stopped on the left-hand branch of the tree at the signals S^{J-2} and d^{J-2}, which will not be broken down, because the sum of their costs is greater than or equal to the cost of their parent signal S^{J-1}.

In this embodiment of the invention, a choice is made to use an entropy criterion to weight the tree of the breakdowns: the value of the cost function at the breakdown node corresponding to the signal S^{j} will have the value:

$$cost = - {\sum }_{k} {\sum }_{l} {\sum }_{m} {\sum }_{n} {( {S}_{klmn}^{j} )}^{2} ln ( {( {S}_{klmn}^{j} )}^{2} )$$

This cost function defines the Shannon's entropy, which measures the quantity of information, that is of different coefficients in a breakdown. This criterion is useful to the coding method according to the invention because the lower cost entropic breakdown is thus retained.

As a variant, in the case where the BTF coded according to the invention is initially expressed on integer numbers, the wavelet analysis performed in this step C2 is an integer breakdown into wavelets or an integer breakdown into packets of wavelets. Such a method is described in the article “Reversible image compression via multiresolution representation and predictive coding”, by A. Said and W. Pearlman, published in 1993 on the occasion of an international conference “Visual Communications and Image Processing”. This further optimizes the wavelet analysis by limiting the size of the result of this analysis. In practice, the data obtained from the analysis are thus represented with fewer resources, the size in bytes of an integer being less than that of a decimal number. It should be noted that any wavelet base can be modified to perform such an integer breakdown. For example, the transformation by the Haar wavelet of the signal S^{j} according to the index k becomes:

$${d}_{{k}^{′} lmn}^{jg} = {S}_{( 2 {k}^{′} + 1 ) lmn}^{j} - {S}_{( 2 {k}^{′} ) lmn}^{j}$$

$$then$$

$${S}_{{k}^{′} lmn}^{jh} = {S}_{( 2 {k}^{′} ) lmn}^{j} + ⌊ \frac{{d}_{{k}^{′} lmn}^{jg}}{2} ⌋$$

where └u┘ designates the integer value of a default division u.

Finally, the step C3 of the coding method according to the invention is the compression of the data obtained at the end of the step C2, the result of the wavelet analysis of the data of the BTF reorganized and reformatted in the step C1.

In this embodiment, this compression uses a “zerotree” coding, which exploits the tree structure of the breakdown into wavelets. This coding technique known to those skilled in the art is, for example, detailed in the following articles:
“An embedded wavelet video coder using three-dimensional set partitioning in hierarchical trees (SPIHT)” by B.-J. Kim and W. A. Pearlman, published in 1997 on the occasion of an international conference “Data Compression Conference”,
and “An embedded hierarchical image coder using zerotrees of wavelet coefficients”, by J. M.

Shapiro, published in 1993 on the occasion of another international conference “Data Compression Conference”.

The principle of this coding technique is to consider that the low-resolution coefficients contained in the signals S^{j} are great compared to the detail coefficients contained in the signals d^{j}, and that the smaller j becomes, the greater the detail coefficients become. This makes it possible to use the interscale dependency of these coefficients, that is, between two breakdown levels, to perform the coding of the data.

More specifically, a detail coefficient at the roughest level is linked to a number of coefficients situated at the higher level in one and the same direction, then these coefficients are in turn linked to the next level, and so on. This number is equal to a power of two, this power being equal to the dimension of the analysis space.

For example, if the breakdown into packets of wavelets retained is that shown in FIG. 10, that is, the data obtained at the end of the step C2 are those of the signals S^{J-3}, d^{J-3}, d^{J-2}, S_{dJ-1}^{J-3}, d_{dJ-1}^{J-3} and d_{dJ-1}^{J-2}, a coefficient of the signal d^{J-3} is linked to 16 coefficients of the signal d^{J-2}.

It should be noted that, since the “zerotree” coding method is usually applied to the breakdowns into wavelets, a few adaptations are necessary to apply it to a breakdown into packets of wavelets, as detailed in the article “Adaptive wavelet packet basis selection for zerotree image coding”, by N. Rajpoot, R. Wilson, F. Meyer and R. Coifman, published in 2003 in the review “Institute of Electrical and Electronics Engineers (IEEE) Transactions on image processing”.

In practice, the hierarchy in the “zerotree” coding sense, is no longer the same as in a conventional breakdown into wavelets. Certain rules for incorporating the coefficients of one level in another must therefore be added to retain a real decrease in the coefficients on working through the breakdown levels.

Thus, in FIG. 10, if the signal d^{J-2} had been further broken down on a final level J−3, a coefficient of the signal d^{J-3} would have been linked not to 16 coefficients of the signal J^{J-2}, which would not be retained at the end of the step C2, but to a coefficient in each of the 16 signals obtained from the breakdown of the signal d^{J-2}.

Similarly, by applying the same rule as described hereinabove for the signal d^{J-2}, a coefficient of the signal d^{J-2} would need to be linked to a coefficient in each of the 16 signals obtained from the breakdown of the signal d^{J-1}. Now, the signal S_{dJ-1}^{J-2} obtained from this breakdown is itself further broken down, notably into a signal S_{dJ-1}^{J-3} of rougher level than that of the signal d^{J-2}. In order to comply with the “zerotree” coding principle, the coefficients of the signals S_{dJ-1}^{J-3} and d_{dJ-1}^{J-3} are linked not to the coefficients of the signal d^{J-2} but to the coefficients of the signal d^{J-3}. The values of the coefficients of the signals S_{dJ-1}^{J-3} and d_{dJ-1}^{J-3} will thus be coded according to those, theoretically greater, of the coefficients of the signal d^{J-3}. This intrinsic quantization performed by the “zerotree” coding is also called “quantization by successive approximation”.

On completion of this “zerotree” coding, a stream of bit is obtained at the end of the step C3 which codes the breakdown into wavelet packets performed in the step C2. The data obtained in this way have a size which is far less than at the end of the step C2. In practice, the fact of exploiting the decrease in coefficients through the scales, added to the fact that the wavelet analysis produces numerous coefficients close to zero, enables the “zerotree” coding method to obtain a high compression rate. Furthermore, the data obtained are organized by order of importance, as represented in FIG. 11. The data ZT0 code coefficients corresponding to the roughest level of detail, whereas the data ZT1 code detail coefficients at a slightly less rough level, the data ZT2 code detail coefficients at a yet finer level, and so on. The data ZT0 correspond to information that most describes the original data. A progressive representation of the texture is thus obtained, inasmuch as the data situated after the data ZT0 make it possible to progressively refine the rough representation of the texture contained in these data ZT0. Thus, when only the first data of this representation obtained at the end of the step C3 are transmitted, a rough representation of the texture is obtained.

As a variant, in this step C3, instead of using a “zerotree” coding, a dynamic “Huffman” type coding is used together with a nonuniform scalar quantization. In particular, the Y component of the data obtained from the step C2 is less quantized than the U and V components. The step of this quantization is, for example, set appropriately for a size of the fixed compressed data. This method, called “Rate Allocation”, is used in the “Joint Photographic Experts Group (JPEG) 2000” standard. For this, the quantization step is calculated, for example, iteratively until the desired compression rate is achieved. This post-processing is useful, for example, when transmitting compressed data over a network at a fixed bit rate. Furthermore, such a quantization can be adapted to quantize less certain areas of interest of the texture, if such areas are identified, compared to the other areas of lesser interest.

This variant makes it possible to reduce the complexity of the calculations on decompression, but is much less effective in terms of compression rate than the main variant embodiment of the invention. It should be noted that it is also possible to couple the “zerotree” coding of the main variant of the invention with a dynamic “Huffman” type coding, but this would improve the compression rate of the data obtained only very little.

The decoding method according to the invention is now described in conjunction with FIGS. 4 and 12. The data obtained at the end of the step C3 are sent by the computer ORD to a remote terminal T over a communication network RES. The corresponding data stream F contains the representation of the “zerotree”-coded data organized in order of importance as described hereinabove in relation to FIG. 11.

On receiving the data stream F, the terminal T stores in memory all the data received, or only the first data, for example the data ZT0, ZT1 and ZT2 if the terminal T has a limited memory capacity, or if a communication failure interrupts the sending of the data just after the data ZT2 have been sent.

The terminal T, after channel-decoding the signal conveying the data stream F, decodes the received data according to the steps D1 to D3 represented in FIG. 12.

The step D1 is the decompression of the received data. For this, the terminal T uses a “zerotree” decoding algorithm which is the reverse of that used in the step C3 for the coding, that is, it uses the same rules of association of the coefficients from one level of resolution to another to retrieve the data obtained from the breakdown into wavelet packets. If only the data ZT0, ZT1 and ZT2 are decompressed, only the coefficients of the first levels of resolution of the breakdown into wavelet packets of the step C2 are obtained.

Moreover, on “zerotree” coding, the local nature of the wavelet analysis is retained. Thus, on decoding, the terminal T is able to decode only a portion of the received data, in order, for example, to render the texture only from certain directions of points of view or certain direction of the light.

The step D2 is the wavelet synthesis of the data decompressed in the step D1. Since the “zerotree” coding is dependent on the structure of the wavelet packet breakdown tree retained in the step C2, the terminal T easily reconstitutes all or some of the reorganized and reformatted texture data obtained at the end of the step C1. All that is needed for this is to perform reverse Haar transforms in the order of the breakdown into wavelet packets, dimension by dimension.

Finally the step D3 is the reorganization into six dimensions of the data obtained at the end of the step D2. The terminal T thus obtains a texture expressed in the form of a BTF, which can be used directly to perform its rendering on a screen. If only the data ZT0, ZT1 and ZT2 have been synthesized in the step D2, this BTF is in fact a rough representation of the texture compressed according to the invention.

1. Method A method of coding data representative of a multidimensional texture, said data being initially organized on a number of dimensions at least equal to three, at least one of said dimensions being associated with a rendition parameter for said texture, said method comprising the steps of:
wavelet analysis of said data on said dimensions,
and compression of data obtained from the result of said analysis.

2. A method according to claim 1, further comprising a step for reorganization of said data according to a predetermined number of dimensions which is performed prior to said wavelet analysis.

3. A method according to claim 2, wherein, in said reorganization step, said data is arranged so as to maximize the correlation between two successive samples of said data according to at least one dimension.

4. A method according to claim 1, wherein said data represent represents colors according to the YUV color coding system.

5. A method according to claim 1 wherein the compression step uses a “zerotree” type coding.

6. A method of decoding data representative of a multidimensional texture, said data being initially organized on a number of dimensions at least equal to three, at least one of said dimensions being associated with a rendition parameter for said texture, said method comprising the steps of:
decompression of said data,
and wavelet synthesis on said dimensions of data obtained from said decompression.

7. A signal representative of a multidimensional texture initially represented by data organized on a number of dimensions at least equal to three, at least one of said dimensions being associated with a rendition parameter for said texture, wherein said data have been coded by wavelet analysis on said dimensions, then by compression of data obtained from the result of said analysis.

8. A device for coding data representative of a multidimensional texture, said data being initially organized on a number of dimensions at least equal to three, at least one of said dimensions being associated with a rendition parameter for said texture, said device comprising:
wavelet analysis means for said data on said dimensions,
and compression means for data obtained from said analysis means.

9. A device for decoding data representative of a multidimensional texture, said data being initially organized on a number of dimensions at least equal to three, at least one of said dimensions being associated with a rendition parameter for said texture, said device comprising:
decompression means for said data,
and wavelet synthesis means on said dimensions of data obtained from said decompression means.

10. A computer program comprising instructions for implementing the method according to claim 1, when it is run on a computer.
